(19) United States
(12) Patent Application Publication
(10) Pub. No.: US 2024/0308765 A1
(43) Pub. Date: Sep. 19, 2024

(54) DISPATCH METHOD FOR A TRANSPORT ROBOT, DISPATCH SYSTEM AND COMPUTER PROGRAM PRODUCT

(71) Applicant: LINGDONG TECHNOLOGY (BEIJING) CO.LTD., Beijing (CN)

(72) Inventors: Xu WANG, Beijing (CN); Tiedong BIAN, Beijing (CN); Pengfei WANG, Beijing (CN); Guangpeng ZHANG, Beijing (CN)

(21) Appl. No.: 18/575,272

(22) PCT Filed: May 30, 2022
(86) PCT No.: PCT/CN2022/095917

§ 371 Date: Dec. 28, 2023

(30) Foreign Application Priority Data
Jul. 2, 2021 (CN) 202110748709.X

(51) Int. Cl. B65G 1/137; G06Q 10/087

(52) U.S. Cl. CPC B65G 1/1373; G06Q 10/087

(57) ABSTRACT

The present disclosure relates to the field of intelligent logistics. The disclosure provides a dispatch method for a transport robot, which comprises steps of: S1: assigning a heat value to each order in an order pool according to a picking friendliness index; S2: selecting, in response to an order assignment demand, an order whose heat value meets a preset condition from the order pool; S3: generating a dispatch instruction for at least one transport robot based on the selected order. The present disclosure further provides a dispatch system and a computer program product. In the dispatch strategy of the present disclosure, orders out of sequence are aggregated and dynamically classified according to the picking friendliness, so that orders that are most conducive to saving manpower at the moment can always be prioritized, thus rationalizing the dispatching of transport robots and human pickers in general, and improving the picking efficiency.

### TECHNICAL FIELD

This disclosure relates to a dispatch method for a transport robot, a dispatch system and a computer program product.

### BACKGROUND ART

With the rise of fields such as e-commerce and modern factories, smart warehouse systems have been increasingly used for item picking, transporting, storage, etc. At present, in the field of smart warehousing and logistics, in order to reduce the burden of human pickers and improve the efficiency of order picking operations, the picking and sowing of materials are generally completed through the collaboration between autonomous mobile robot (AMR) and humans.

In the commonly used dispatch modes known in the prior art, orders are usually assigned in sequence according to the ordering time, or orders are reorganized according to the category of goods before assignment, and then transport robots and human pickers complete picking tasks by cooperating with each other in a “vehicle-to-person” or “goods-to-person” manner.

However, these solutions have many limitations. In particular, it may seem simple and easy to assign tasks purely following the arrival sequence of orders, but it is disorganized for the task execution side, so most of the time the human pickers have to walk a long distance or wait for the transport robots for a long time at the same picking location, which makes it impossible to achieve optimal picking efficiency overall. However, rearranging the orders will significantly increase the time cost of sorting.

With this background, it is expected to provide an improved dispatch method for logistics robots, aiming to achieve rational dispatch of orders, robots, and personnel to improve the picking efficiency.

### SUMMARY OF THE INVENTION

It is an object of the present disclosure to provide a dispatch method for a transport robot, a dispatch system, as well as a computer program product by which at least some of the problems in the prior art can be solved.

One aspect of the disclosure relates to a dispatch method for a transport robot, comprising the following steps:
S1: assigning a heat value to each order in an order pool according to a picking friendliness index;
S2: selecting, in response to an order assignment demand, an order whose heat value meets a preset condition from the order pool; and
S3: generating a dispatch instruction for at least one transport robot based on the selected order.

In the sense of the present disclosure, the picking friendliness index is also referred to “human efficiency value index”, which is directly related to the overall manual picking efficiency. With the help of this index, the value of the orders can be comprehensively evaluated in terms of the travel distance, moving range, and waiting time, etc. of the human picker. The heat value evaluated using this index can particularly reflect the friendliness of different orders to human pickers. In the above dispatch strategy, orders out of sequence can be aggregated and dynamically classified according to the picking friendliness, so that orders that are most conducive to saving manpower at the moment can always be prioritized, thus rationalizing dispatching of the transport robots and human pickers in general, and improving the picking efficiency.

Optionally, step S3 further comprises: generating a dispatch instruction for at least one human picker based on the selected order.

Optionally, the picking friendliness index includes a static index and a dynamic index, the static index does not change with order contents in the order pool, while the dynamic index changes with the order contents in the order pool.

Here, in particular the following technical advantages can be achieved: Due to the dynamic component of the picking friendliness index, orders that were originally evaluated as having a low picking friendliness will change into orders of high picking friendliness with the succession of old and new orders in the order pool as well as the type and quantity of goods. It can be seen that as time goes on, this dynamic order assignment can achieve an order assignment solution tending to maximize the human efficiency overall.

Optionally, step S1 comprises: obtaining a statistical distribution of goods included in each order in the order pool over picking positions; selecting a certain number of picking locations based on the statistical distribution, and extending at least one area outwardly from the certain number of picking locations as a hot zone; and determining the heat value based on a proportion of the picking locations corresponding to the goods included in each order in the hot zone.

Here, the establishment of hot zones associates the order pool with the warehouse map, realizes mapping from the dimension of goods to the dimension of picking locations, and it also tells which areas are more conducive to intensive human picking, so that picking routes of the transport robots and work areas of the human pickers can be planned in a more rational manner.

Optionally, the hot zone is in units of an aisle area including picking locations, wherein different hot zones differ from one another particularly in size and/or shape.

Optionally, the statistical distribution is projected onto a warehouse map to generate a visual heat map, from which an area with the deepest color is selected as the hot zone.

Here, in particular the following technical advantages are achieved: by generating the heat map, dynamic changes and development trends of the hot zone can be visualized. In addition, it can also be seen more clearly whether the moving routes of human pickers and transport robots perfectly coincide with the hot zones, and in case of a large deviation, the size or shape of the hot zone can be timely adjusted.

Optionally, step S1 comprises: determining the heat value according to an aggregation degree of the picking locations corresponding to the goods included in the order.

Here, in particular the following technical advantages are achieved: the more clustered the picking locations are, the more concentrated the goods are distributed on racks close to each other, which means there is no need to move across a long distance to complete the order task, and therefore this constitutes an important measure of order-friendliness.

Optionally, step S1 comprises: determining the heat value according to the quantity of the goods included in the order.

Here, in particular the following technical advantages are achieved: the heat value is constrained by a length of the order, which can prevent those small orders from all being assigned in advance, thereby avoiding the frequent change of the location of the hot zone. In addition, small orders mean higher flexibility and therefore do not have to take up a major share of the assignment, but can be interpolated into the task list when the tasks in the hot zone are mostly completed or during the task intervals of the human picker so as to be executed without affecting the overall efficiency.

Optionally, the dispatch method further comprises:
when a total heat value of unassigned orders is lower than a first threshold, re-determining the picking friendliness index, in particular re-determining hot zones, for all the unassigned orders; and/or
when a remaining total heat value of all assigned but uncompleted orders is lower than a second threshold, returning the uncompleted orders to the order pool as new orders, and re-determining the picking friendliness index, in particular re-determining hot zones, for all the orders currently present in the order pool.

Here, in particular the following technical advantages are achieved: as new orders are continuously added to the order pool, the originally determined evaluation index may become “outdated” with the changing order contents and therefore no longer applicable. It is also possible that part of a complete order reflects a higher heat value, while the remainder does not. In both cases, the picking friendliness index can be timely updated, so that the calculated heat value can be dynamically adapted to the order pool at different stages.

Optionally, the dispatch method further comprises: after sending the dispatch instruction to at least one transport robot and/or at least one human picker, monitoring in real time the picking efficiency, completeness of remaining orders, congestion rate, number of assigned transport robots and/or ratio of the number of transport robots to the number of human pickers in each work area, and updating the dispatch instruction for at least one transport robot and/or at least one human picker based on monitoring results.

In this way, tasks can be balanced in real time during the order execution process, so that the optimal picking efficiency can be achieved at any time.

Optionally, updating the dispatch instruction for at least one transport robot comprises: updating a picking route; and/or updating the dispatch instruction for at least one human picker comprises: instructing at least one human picker to leave a current work area.

Optionally, step S2 comprises: ranking the orders in the order pool according to their heat values, and selecting an order with the largest heat value in response to the order assignment demand.

Optionally, step S3 comprises: sending a picking list corresponding to the selected order and information of the hot zone to a handheld communication device of at least one human picker, in order to guide the at least one human picker to the hot zone to pick up goods in the hot zone.

Here, sending the information related to the hot zone to the human picker can fully inform the human picker of the area where tasks are densely distributed, so that when assisting the transport robot to complete the picking task, the human picker can consciously plan his/her traveling route to not deviate from the core area.

Optionally, step S3 comprises: assigning the at least one human picker, additionally based on a predicted travel distance and/or waiting time of individual human pickers: to travel to a predetermined picking location within a current hot zone, a travel path within the current hot zone, and/or a docking sequence with the transport robots within the current hot zone; and/or assigning at least one further human picker already located within the current hot zone, additionally based on a predicted travel distance and/or total waiting time of all human pickers, to travel to a predetermined picking location outside of the current hot zone.

Here, by planning the movement of humans inside the hot zone, it is possible to develop personalized dispatch plans for individual human pickers, thus reducing the travel distance and also the waiting time of individual human pickers. In addition, through dynamic cross-area dispatch, conflicts over robotic vehicle allocation can be solved, and the efficiency between different work areas can be balanced to achieve an overall optimized picking efficiency.

Optionally, the dispatch instruction is generated additionally based on a moving speed of at least one transport robot, a picking speed and/or moving speed of at least one human picker, the number of remaining picking tasks of at least one human picker and/or in at least one work area, wherein the dispatch instruction in particular includes assigning a next picking location to the transport robot and/or the human picker.

Here, performance parameters of candidate transport robots and status parameters of candidate human pickers are also taken into account when generating the dispatch instruction, so that the order tasks can be assigned in a more reasonable manner.

Optionally, the dispatch instruction includes assigning picking modes, wherein a non-binding picking mode is assigned to transport robots and human pickers in a determined work area, in particular in a hot zone, while a binding picking mode is assigned to transport robots and human pickers in a determined work area, in particular outside the hot zone.

Here, in particular the following technical advantages are achieved: in areas where orders are densely distributed, transport robots come and go frequently, so generally human pickers do not have to wait for the robotic vehicles for a long time. In this case, it is possible to arrange one human picker to cooperate flexibly with multiple robotic vehicles to complete the picking task. In areas where orders are sparsely distributed, there is a high probability that human pickers are idle or have to wait for a long time, so it is advantageous to change the mode in these areas into a follow-picking mode.

A second aspect of the present disclosure relates to a dispatch system, which is used for performing the dispatch method according to the first aspect of the disclosure, wherein the dispatch system comprises:
an analysis module, which is configured to assign a heat value to each order in an order pool according to a picking friendliness index;
a selection module, which is configured to select, in response to an order assignment demand, an order whose heat value meets a preset condition from the order pool; and
an order assignment module, which is configured to generate a dispatch instruction for at least one transport robot based on the selected order.

A third aspect of the present disclosure relates to a computer program product comprising a computer, which, when executed by a computer, performs the dispatch method according to the first aspect of the disclosure.

### BRIEF DESCRIPTION OF THE DRAWINGS

The principles, characteristics and advantages of the disclosure can be better understood by describing the disclosure in greater detail with reference to the accompany drawings, in which:

FIG. 1 shows a flow chart of a dispatch method for a transport robot according to an exemplary embodiment of the present disclosure;

FIG. 2 shows a flow chart of one step of the dispatch method for a transport robot according to the present disclosure;

FIG. 3 shows a flow chart of another step of the dispatch method for a transport robot according to the present disclosure;

FIG. 4 shows a flow chart of two steps of the dispatch method for a transport robot according to the present disclosure;

FIG. 5 shows a schematic diagram of formation of hot zones according to an exemplary embodiment of the present disclosure;

FIG. 6 shows a schematic diagram of applying the dispatch method according to the present disclosure in a warehouse; and

FIG. 7 shows a block diagram of a dispatch system according to an exemplary embodiment of the present disclosure.

### DETAILED DESCRIPTION OF EMBODIMENTS

For a clearer understanding of the technical problems to be solved, technical solutions and advantageous technical effects of the present disclosure, the disclosure will be further described below in details in conjunction with the drawings and a number of exemplary embodiments. It is to be understood that specific embodiments described herein are merely for explaining the disclosure, rather than limiting the scope of protection of the disclosure.

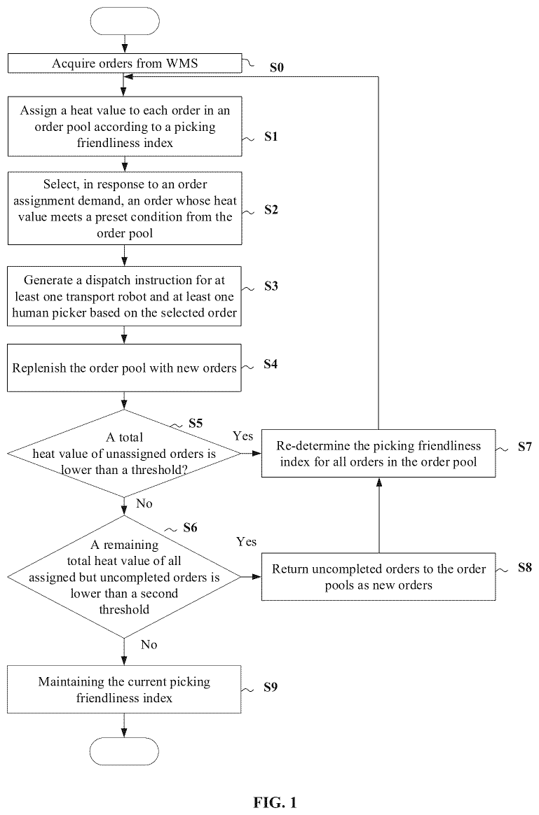

FIG. 1 shows a flow chart of a dispatch method for a transport robot according to an exemplary embodiment of the present disclosure.

In step S0, orders are acquired from a warehouse management system (WMS) and imported into an order pool.

In step S1, a heat value is assigned to each of the orders in the order pool according to a picking friendliness index. Here, this picking friendliness index is used to characterize a degree of contribution of each order to the overall improvement of picking efficiency, and the picking friendliness index includes, for example, a static index and a dynamic index, the static index does not change with order contents in the order pool, while the dynamic index changes with the order contents in the order pool. As a result of the existence of the dynamic index, as the state of the order pool continuously changes (new orders are added, and old orders are removed), one order in the order pool can be assigned different heat values at different times, thus showing different picking friendliness indexes.

In step S2, in response to an order assignment demand, an order whose heat value meets preset conditions is selected from the order pool. Here, the order assignment demand refers to a request of order assignment received from a transport robot and/or a human picker, but it is also possible that an idle transport robot or human picker is observed by a dispatch platform, thus an order assignment demand is actively generated. As an example, selecting an order whose heat value meets a preset condition from the order pool includes: ranking the orders in the order pool according to their heat values, and selecting an order with the largest heat value in response to the order assignment demand.

In step S3, a dispatch instruction for at least one transport robot is generated based on the selected order. In addition, a dispatch instruction for at least one human picker can also be generated based on the selected order. Here, for example, the selected order is first converted into a picking list at least including picking locations, and then is assigned to at least one transport robot and at least one human picker. Here, the dispatch instruction for the transport robot at least includes a picking route, and the dispatch instruction for the human picker at least includes picking locations.

In an optional step S4, it is checked whether order updates are acquired from WMS, and the order pool is replenished with new orders if there are updates. Here, newly added orders still participate in the heat value ranking with the predefined picking friendliness indexes.

In an optional step S5, it is checked whether a total heat value of all currently unassigned orders in the order pool is lower than a first threshold.

If this is the case, it means that as new orders are continuously added in, the preset picking friendliness indexes have become “outdated” and therefore no longer applicable to the current state of the order pool. In order to improve this situation, in an optional step S7, for example, the picking friendliness index can be re-determined for all orders in the order pool, and a heat value is assigned to each of the orders based on the updated picking friendliness index.

If this is not the case, then in an optional step S6, it is checked whether a remaining total heat value of all assigned but uncompleted orders is lower than a second threshold.

If it is found that the remaining total heat value has already become lower than the second threshold, it means that though some of the orders have a relatively high overall heat value, the heat value is unevenly distributed within the order. Therefore, in an optional step S8, all the uncompleted orders will be returned to the order pool as new orders, and the picking friendliness index is re-determined for all the unassigned and uncompleted orders.

If it is found in step S6 that the remaining total heat value is higher than the second threshold, it means that the currently set picking friendliness indexes are still appropriate, so the existing picking friendliness indexes can still be used in step S9.

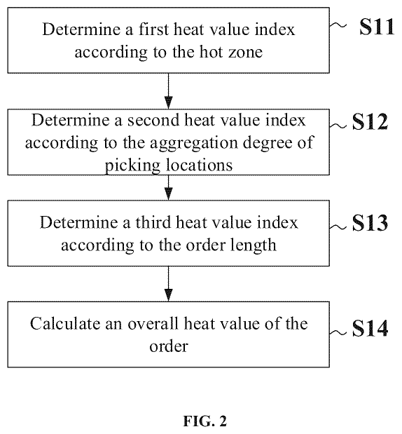

FIG. 2 shows a flow chart of one step of the dispatch method for a transport robot according to the present disclosure. As shown in FIG. 2, the method step S1 in FIG. 1 exemplarily includes sub-steps S11-S14 to illustrate how to comprehensively calculate the heat value of each order through multiple evaluation indicators.

In step S11, a first heat value component is calculated by constructing a hot zone. Here, for example, a statistical distribution of the goods included in each order in the order pool over picking locations shall be obtained, and then a certain number of picking locations are filtered out according to the statistical distribution, and at least one area is designated as a hot zone by extending outwardly from the picking locations. As an example, the entire warehouse shall be divided into multiple determined areas, and it is checked whether the number of picking locations or the cumulative number of times the picking locations in each determined area will be traversed exceeds a threshold, and if so, this determined area is defined as a hot zone. As another example, it is also possible to first aggregate all picking locations whose distance is less than a threshold, and then check whether the number of picking locations or the cumulative number of times the picking locations in each determined area will be traversed exceeds a threshold, and if so, this determined area is defined as a hot zone. In addition, it is also possible to dynamically merge or split to form new hot zones based on the geographical locations and/or the proportion of the picking locations in the hot zone. Finally, the heat value component is determined based on the proportion of the picking locations corresponding to the goods included in each order in the hot zone. Here, the higher the proportion of the picking locations of the goods included in the order in the hot zone, the higher the heat value component.

As an example, the first heat value component determined in this way is calculated by the following equation:

$${cost}_{mean} = \frac{{n}_{in}}{n}$$

In which costₘₑₐₙ represents the first heat value component, nᵢₙ represents the number of locations of the goods included in the order in all hot zones, and n represents the total number of locations of the goods included in the order.

In step S12, a second heat value component is determined according to an aggregation degree of the picking locations corresponding to the goods included in the order. As an example, the more clustered the picking locations, the higher the heat value component. This aggregation degree can particularly be characterized by a dispersion degree of the picking locations in different hot zones. For example, the second heat value component is calculated by the following equation:

$${cost}_{dispersion} = {\sum }_{i = 1}^{k} \frac{{( {n}_{i} - n / k )}^{2}}{n}$$

In which cost_{dispersion} represents the second heat value component, k represents the number of hot zones, i belongs to [1,k], ni represents the number of locations of the goods included in the order in the i^{th} hot zone, and n represents the total number of locations of the goods included in the order. It can be seen from this equation that the fewer hot zones the locations of the goods included in each order are concentrated in, the higher the heat value.

In step S13, a third heat value component is determined based on a length of the order, namely, the quantity of the goods included in the order. As an example, the longer the order, the higher the heat value component. This can particularly prevent orders of a shorter length from being mistakenly prioritized due to the evaluation indicators in steps S11 and S12, which actually will lead to a reduction in the overall picking efficiency. Therefore, the third heat value component is calculated by the following equation:

cost_{length}=\sqrt{n}

In which cost_{length} represents the third heat value component, and n represents the total number of locations of the goods included in the order.

Next, in step S14, an overall heat value of an order is comprehensively calculated. As an example, the overall heat value of the order can be calculated by the following equation:

$$cost = {cost}_{mean} \times {cost}_{dispersion} \times {cost}_{length}$$

Here, the above calculation manner of the overall heat value is only an example; it is also conceivable to assign a weight to individual heat value components and consider the individual heat value components in a weighted manner. The specific formula for calculating the overall heat value is not to be limited here.

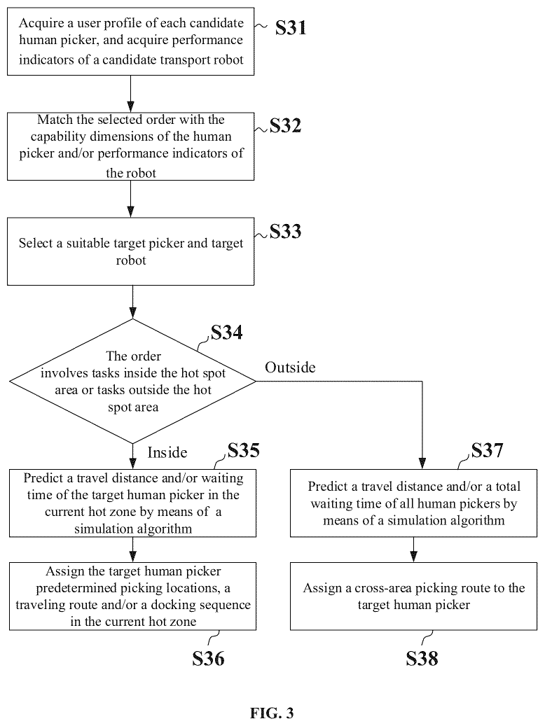

FIG. 3 shows a flow chart of another step of the dispatch method for a transport robot according to the present disclosure. As shown in FIG. 3, the method step S3 in FIG. 1 exemplarily includes sub-steps S31-S38 to illustrate how to generate a dispatch instruction while additionally considering multiple factors.

In step S31, a user profile of each candidate human picker is acquired, and performance indicators of each candidate transport robot is acquired. Here, the candidate human pickers and the candidate transport robots are particularly understood as those human pickers or robots that are idle or whose workload to be carried out is not saturated at the time of order assignment. The user data profile includes, for example, summary statistics on the following capability dimensions of a human picker: moving speed, picking speed, average picking efficiency, physical status, and remaining number of tasks to be performed currently. The performance indicators of a transport robot include, for example: moving speed, version, intelligence level, year of manufacture, etc. of the transport robot.

In step S32, the selected order is matched with the capability dimensions of the human picker and/or the performance indicators of the robot.

In step S33, suitable target human pickers and target transport robots are selected based on the matching. As an example, orders with a larger amount of tasks and requiring frequent cross-area operations shall be prioritized and assigned to those fast-moving transport robots and human pickers having high picking efficiency, while orders with a fewer amount of tasks and more intensively distributed picking locations shall be assigned to those slow-moving transport robots and human pickers.

In step S34, for example, it is checked whether the selected order involves tasks inside the hot zone or tasks outside the hot zone.

If it involves tasks inside the hot zone, in step S35, a travel distance for the target human picker to dock with the transport robots already located inside the hot zone in different sequences and/or a waiting time for the target human picker to wait for the transport robots can be predicted using a simulation algorithm.

Then in step S36, the target human picker is assigned predetermined picking locations, a traveling route and/or a docking sequence in the current hot zone based on an optimal solution obtained through traversal.

If tasks outside the hot zone is involved, in step S37, a travel distance and/or a total waiting time of all human pickers, including the target human picker, can be predicted using a simulation algorithm.

Then in step S38, a cross-area picking route or picking locations are assigned to the target human picker based on the predicted results to achieve the optimal overall picking efficiency.

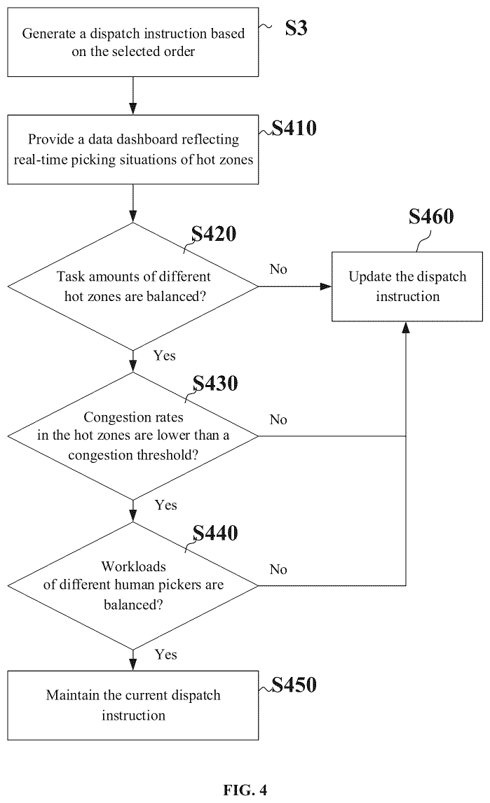

FIG. 4 shows a flow chart of two steps of the dispatch method for a transport robot according to the present disclosure. As shown in FIG. 4, the method in FIG. 1 further exemplarily includes sub-steps S410-S460 after step S3 to illustrate how to update the assigned dispatch instruction, after the dispatch instruction assignment, based on the results of real-time monitoring.

After a dispatch instruction is generated in step S3, for example, a data dashboard that can reflect the picking situation in each hot zone in real time can be provided in step S410. Such a data dashboard includes, for example: picking efficiency in each work area, completeness of remaining orders, congestion rate, number of assigned transport robots and/or ratio of the number of transport robots to the number of human pickers in each work area.

In step S420, it is determined, for example, based on the monitoring results provided by the aforementioned data dashboard that whether the amounts of tasks in different hot zone are balanced.

If orders are unevenly distributed, most probably the human pickers in some intensive work areas will be very busy, while the human pickers in low-intensity work areas will have a longer waiting time and a longer travel distance. Therefore, if it is determined that an imbalance occurs, the dispatch instruction may be updated in step S460. Here, for example, more human pickers or transport robots are dispatched to those work areas with a higher workload, and the working mode of human pickers and transport robots in work areas with a fewer amount tasks shall be adjusted (e.g. from a non-binding picking mode to a binding picking mode).

If no task balance problem is found, the method may proceed to step S430 where whether the congestion rates in the hot zones are lower than a congestion threshold is checked.

If the congestion rate in some hot zones is higher than the congestion threshold, while the congestion rate in other hot zones is much lower than the congestion threshold, there may be an imbalance in the density of traffic flow in these work areas. Thus, for example, the dispatch instruction shall be updated again in step S460. As an example, the picking route of the transport robot in a work area with a higher congestion rate shall be updated so that it prioritizes the picking tasks in other hot zones, or the human picker in the current hot zone is assigned to other picking locations outside the current hot zone so that the picker temporarily leaves the current hot zone, thereby alleviating the congestion in the current hot zone.

If there is no congestion problem, based on the monitoring results, it is further determined in step S440 that whether the workloads for the human pickers are balanced.

An unbalanced workload particularly means that human pickers who are less efficient or in poor physical condition are assigned more work than they can handle, while the tasks for some more efficient human pickers are unsaturated. So in this case, the dispatch instruction may also be updated in step S460. As an example, the orders or part of the orders initially assigned to an overloaded first human picker are transferred to an underloaded second human picker, thereby achieving a dynamic balance in workload levels and benefiting higher overall picking efficiency.

If the monitoring results do not reflect any imbalance, the current dispatch instruction remains unchanged in step S450 to prompt the human pickers or transport robots to continue with the tasks according to the already assigned dispatch instruction.

It should be noted here that this exemplary embodiment is not intended to limit the execution order of steps S420 to S440, and it is also possible that these steps are executed in parallel or in other orders.

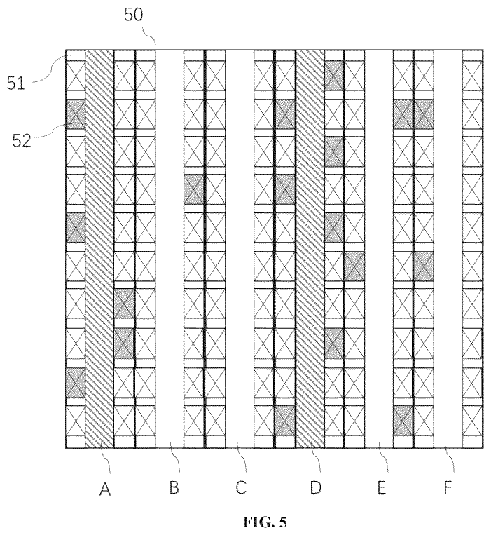

FIG. 5 shows a schematic diagram of formation of hot zones according to an exemplary embodiment of the present disclosure.

As shown in FIG. 5, a warehouse 50 includes a total of six aisles, A, B, C, D, E, and F, with each aisle having a rack 51 on both left and right sides, and each rack 51 containing ten picking locations 52. In order to form a hot zone, a statistical distribution of the goods included in each order in the order pool over the picking locations 52 is first requested. This statistical distribution is then projected, for example, onto a warehouse map to generate a visual heat map shown in FIG. 5.

As an example, a threshold for forming a hot zone is set to 5, which means that, for example, if there are at least five locations that are to be picked on both sides of an aisle, then this aisle is defined as a hot zone.

In the embodiment shown in FIG. 5, the locations to be picked are marked in dark colors, and it can be seen that aisles A to F each include 5, 1, 0, 7, 3 and 2 locations to be picked in sequence. Therefore, based on the aforementioned criterion of hot zone formation, it can be determined that aisles A and D are hot zones.

As another example, an initial heat degree for each location on the rack and a heat degree increment of this location when being traversed each time is defined in advance. When the goods in different orders repeatedly involve the same location, the initial heat degree of this location is accumulated with heat increments. Here, the number of times that a location becomes a picking location can be indicated in particular by the shade of colors, whereby it is also possible to assign weight scores to these picking locations according to the shade of colors, so that for the determination of hot zones, not only the number of the involved locations but also the repetition rate of the locations can be taken into consideration. In this way, the hot zones can be more accurately determined.

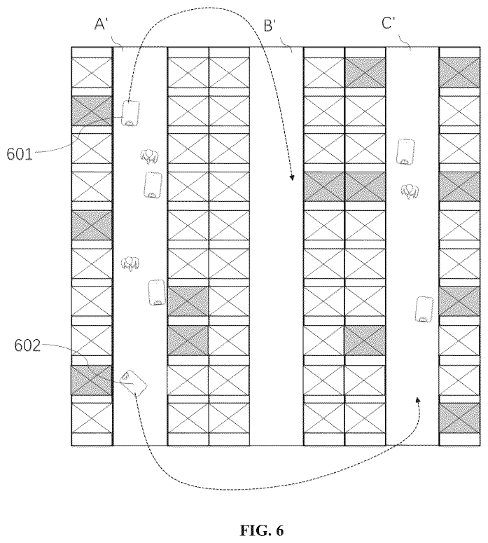

FIG. 6 shows a schematic diagram of applying the dispatch method according to the present disclosure in a warehouse.

In this example, aisles A′ and C′ have been identified as hot zones. The distribution of transport robots and human pickers in each aisle can be seen in the drawing.

Here, there are four transport robots and two human pickers in a first hot zone (i.e. aisle A′). It can be seen that the aisle A′ is relatively crowded. However, there are actually more tasks but fewer transport robots and human pickers in a second hot zone (i.e. aisle C′) than in the first hot zone. And it can also be seen that although a fewer number of tasks are distributed in aisle B′ (only one location to be picked), there is no transport robot or human picker in this aisle at all to perform the task.

In this case, for example, the task completion status in the first hot zone is known through the data dashboard. As an example, if it is found from the data dashboard that a transport robot 601 has few remaining tasks in this hot zone, the picking route of the transport robot 601 originally in aisle A′ shall be updated to make it finish the picking tasks in aisle B′ first, and meanwhile an idle human picker is also dispatched to aisle B′. As another example, it is found from the data dashboard that the locations to be picked by a transport robot 602 also include several locations in aisle C′, so in order to alleviate the congestion in aisle A′, the picking route of the transport robot 602 originally in aisle A′ shall also be updated to instruct the transport robot 602 to leave the current hot zone and go to the second hot zone (i.e. aisle C′). Through this real-time updated dispatching, task amounts are balanced among various work areas and congestion is alleviated.

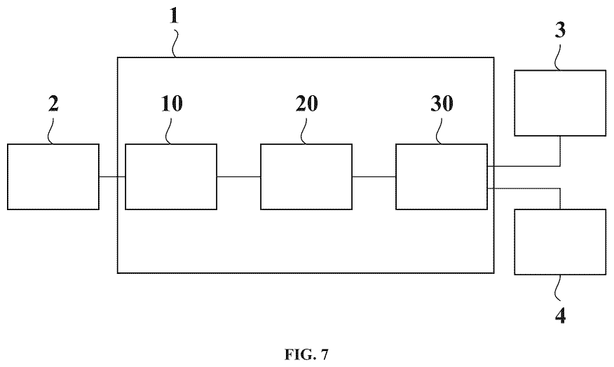

FIG. 7 shows a block diagram of a dispatch system according to an exemplary embodiment of the present disclosure.

As shown in FIG. 7, a dispatching system 1 comprises an analysis module 10, which is connected to a warehouse management system 2 and is therefore capable of receiving orders therefrom. After importing the corresponding orders into the order pool, the analysis module 10 assigns a heat value to each of the orders in the order pool according to a preset picking friendliness index. Next, the heat value information is transmitted from the analysis module 10 to a selection module 20, so that an order whose heat value meets preset conditions is selected from the order pool in response to an order assignment demand. The selection module 20 is also connected to an order assignment module 30, with which a dispatch instruction for at least one transport robot and for at least one human picker 4 is generated based on the selected order.

While specific embodiments of the disclosure have been described in detail here, they have been presented for the purpose of explanation only and should not be construed as limitations on the scope of the disclosure. Various substitutions, changes and modifications can be devised without deviating from the spirit and scope of the present disclosure.

1. A dispatch method for a transport robot, comprising the following steps:
S1: assigning a heat value to each order in an order pool according to a picking friendliness index;
S2: selecting, in response to an order assignment demand, an order whose heat value meets a preset condition from the order pool; and
S3: generating a dispatch instruction for at least one transport robot based on the selected order.

2. The dispatch method according to claim 1, wherein step S3 further comprises: generating a dispatch instruction for at least one human picker based on the selected order.

3. The dispatch method according to claim 1, wherein the picking friendliness index includes a static index and a dynamic index, the static index does not change with order contents in the order pool, while the dynamic index changes with the order contents in the order pool.

4. The dispatch method according to claim 1, wherein step S1 comprises:
obtaining a statistical distribution of goods included in each order in the order pool over picking positions;
selecting a certain number of picking locations based on the statistical distribution, and extending at least one area outwardly from the certain number of picking locations as a hot zone; and
determining the heat value based on a proportion of the picking locations corresponding to the goods included in each order in the hot zone.

5. The dispatch method according to claim 4, wherein the hot zone is in units of an aisle area including picking locations, wherein different hot zones differ from one another particularly in size and/or shape.

6. The dispatch method according to claim 4, wherein the statistical distribution is projected onto a warehouse map to generate a visual heat map, from which an area with the deepest color is selected as the hot zone.

7. The dispatch method according to claim 1, wherein step S1 comprises: determining the heat value according to an aggregation degree of the picking locations corresponding to the goods included in the order.

8. The dispatch method according to claim 1, wherein step S1 comprises: determining the heat value according to the quantity of the goods included in the order.

9. The dispatch method according to claim 1, wherein the dispatch method further comprises:
when a total heat value of unassigned orders is lower than a first threshold, re-determining the picking friendliness index, in particular re-determining hot zones, for all the unassigned orders; and/or
when a remaining total heat value of all assigned but uncompleted orders is lower than a second threshold, returning the uncompleted orders to the order pool as new orders, and re-determining the picking friendliness index, in particular re-determining hot zones, for all the orders currently present in the order pool.

10. The dispatch method according to claim 2, wherein the dispatch method further comprises:
after sending the dispatch instruction to at least one transport robot and/or at least one human picker, monitoring in real time the picking efficiency, completeness of remaining orders, congestion rate, number of assigned transport robots and/or ratio of the number of transport robots to the number of human pickers in each work area, and updating the dispatch instruction for at least one transport robot and/or at least one human picker based on monitoring results.

11. The dispatch method according to claim 10, wherein updating the dispatch instruction for at least one transport robot comprises: updating a picking route; and/or
updating the dispatch instruction for at least one human picker comprises: instructing at least one human picker to leave a current work area.

12. The dispatch method according to claim 1, wherein step S2 comprises:
ranking the orders in the order pool according to their heat values, and selecting an order with the largest heat value in response to the order assignment demand.

13. The dispatch method according to claim 4, wherein step S3 comprises:
sending a picking list corresponding to the selected order and information of the hot zone to a handheld communication device of at least one human picker, in order to guide the at least one human picker to the hot zone to pick up goods in the hot zone.

14. The dispatch method according to claim 13, wherein step S3 comprises:
assigning the at least one human picker, additionally based on a predicted travel distance and/or waiting time of individual human pickers: to travel to a predetermined picking location within a current hot zone, a travel path within the current hot zone, and/or a docking sequence with the transport robots within the current hot zone; and/or
assigning at least one further human picker already located within the current hot zone, additionally based on a predicted travel distance and/or total waiting time of all human pickers, to travel to a predetermined picking location outside of the current hot zone.

15. The dispatch method according to claim 1, wherein step S3 comprises: generating the dispatch instruction additionally based on a moving speed of at least one transport robot, a picking speed and/or moving speed of at least one human picker, the number of remaining picking tasks of at least one human picker and/or in at least one work area, wherein the dispatch instruction in particular includes assigning a next picking location to the transport robot and/or the human picker.

16. The dispatch method according to claim 1, wherein the dispatch instruction includes assigning picking modes, wherein a non-binding picking mode is assigned to transport robots and human pickers in a determined work area, in particular in a hot zone, while a binding picking mode is assigned to transport robots and human pickers in a determined work area, in particular outside the hot zone.

17. A dispatch system, said dispatch system being configured to perform the dispatch method according to claim 1, and the dispatch system comprising:
an analysis module, which is configured to assign a heat value to each order in an order pool according to a picking friendliness index;
a selection module, which is configured to select, in response to an order assignment demand, an order whose heat value meets a preset condition from the order pool; and
an order assignment module, which is configured to generate a dispatch instruction for at least one transport robot based on the selected order.

18. A computer program product comprising a computer program, which, when executed by a computer, performs the dispatch method according to claim 1.

19. The dispatch method according to claim 2, wherein the dispatch instruction includes assigning picking modes, wherein a non-binding picking mode is assigned to transport robots and human pickers in a determined work area, in particular in a hot zone, while a binding picking mode is assigned to transport robots and human pickers in a determined work area, in particular outside the hot zone.

20. The dispatch method according to claim 3, wherein the dispatch instruction includes assigning picking modes, wherein a non-binding picking mode is assigned to transport robots and human pickers in a determined work area, in particular in a hot zone, while a binding picking mode is assigned to transport robots and human pickers in a determined work area, in particular outside the hot zone.
